(19) United States
(12) Patent Application Publication
(10) Pub. No.: US 2008/0277514 A1
(43) Pub. Date: Nov. 13, 2008

(54) SHREDDER

(76) Inventor: JAMES MOIR CARGILL, KLOOF (ZA)

Correspondence Address: JAMES M. CARGILL, 9 LYNGARTH PARK, 24 LYNGARTH ROAD, KLOOF, 3610, ZA

(21) Appl. No.: 11/744,899

(22) Filed: May 7, 2007

(51) Int. Cl. B02C 13/00

(52) U.S. Cl. 241/186.35

(57) ABSTRACT

A shredding apparatus to reduce the particle size of fibrous material such as sugar cane, consisting of a cylindrical rotor with knives or hammers having a feed conveyor and feeding roll that ensures the material enters the gap between the rotating assembly and a fixed grid plate. The shredded material is discharged from the grid plate onto a fixed discharge plate which leads the shredded cane onto a belt conveyor. Bye-passed material is returned to the feed inlet for reprocessing by means of a return plate. The configuration lends itself to a simple and inexpensive inline installation.

### FIELD OF THE INVENTION

The present invention relates to an apparatus that reduces the particle size of material by passing the material through a rotating set of knives or hammers. Although the specification makes particular reference to reducing the particle size of sugar cane in preparation for sugar extraction, it must be understood that the apparatus can be used for the reduction of particle size of any material that can be processed by means of knifing or shredding, such as timber, vegetable matter, municipal waste, and similar materials.

### BACKGROUND OF THE INVENTION

The sugar juice in sugar cane is generally only available for processing once the cells containing the sugar juice have been ruptured. To attain this, the cane is shredded by means of rotating knives or hammers and cane has to be fed to the rotating assemblies and discharged from them as shredded material.

It is an object of the invention to provide a method of processing large volumes of material, especially sugar cane, and reducing their particle size by conveying the material on a belt conveyor, and forcing it through a rotary set of knives or hammers that discharge the shredded material on to another belt conveyor.

### SUMMARY OF THE INVENTION

The present process of knifing or shredding materials, such as sugar cane, is well known and is similar in principle to the invention. This invention differs in that the rotary set of knives, or hammers, does not revolve above the feed or discharge conveyors, but in line with the feed and discharge conveyors and does not require a conveyor to transport the material through the rotary knives or hammers. This invention will remove the present disadvantage of horizontal rotary knives, or hammers, that require a steel slat conveyor immediately below the rotary knives, or hammers, which makes this conveyor prone to damage.

The use of the invention will enable belt conveyors (a much cheaper alternative to steel slat conveyors) to convey material into a rotating set of knives or hammers horizontally instead of using steel slat conveyors as has been the practice in the past. The use of the invention will enable the shredded material to be discharged horizontally on to a belt conveyor without damage to the belt of the conveyor.

An essential element of the invention is a curved return plate that enables any bye-passed material to be returned to the feed inlet of the rotating knives or hammers for reprocessing. This also reduces any spillage from the apparatus.

The use of the invention will reduce damage to the conveying equipment by the rotary knives or hammers and reduce the cost of equipment required to achieve the specified particle reduction of the material.

### DESCRIPTION OF THE INVENTION

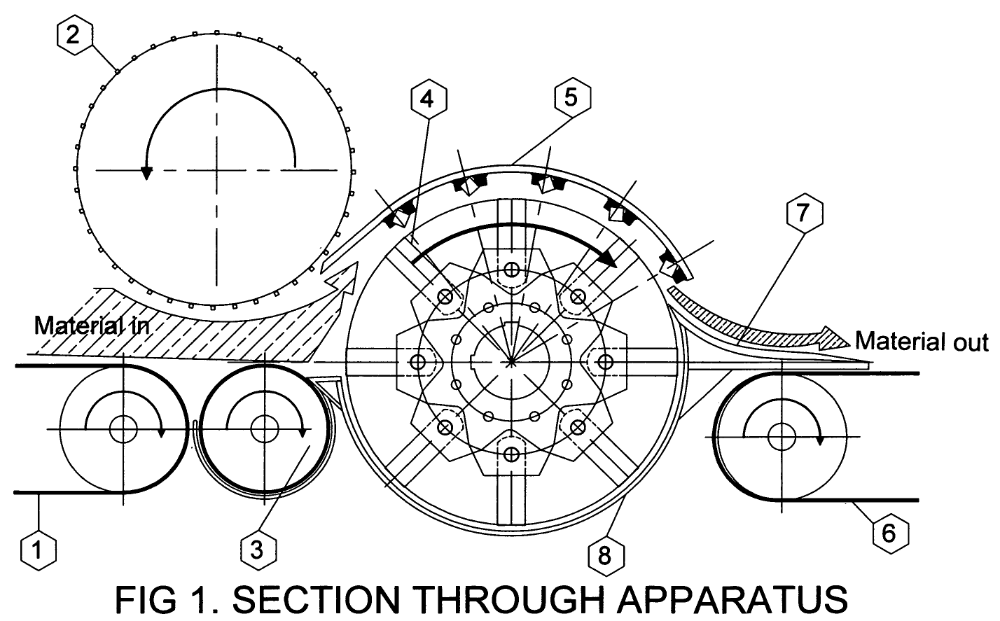

The invention is described with reference to the drawing, FIG. 1.

FIG. 1 is a sectional elevation of the apparatus.

FIG. 1 shows a belt conveyor (1) that feeds material to the particle reduction apparatus. A rotating drum (2), with assistance from the head pulley of belt conveyor (1) and protective pulley or roller (3), pushes the material into the rotary knives, or hammers (4) that shred the material against a grid plate (5) situated above the rotary knives, or hammers. The material is then discharged on to a discharge conveyor (6) by means of a discharge plate (7). Any material that bye-passes the discharge plate (7) is carried back to the feed side of the rotary knives, or hammers, by a curved plate (8) situated below the rotary knives, or hammers, and is re-processed.

1-3. (canceled)

4. A means of recycling bye-passed material from the discharge plate to the feed side of the apparatus for re-processing by means of a curved plate situated below the rotary knives, or hammers.

5. A method of achieving the feeding of material by means of a conveyor, feed drum, and a protective pulley or roller into a set of rotary knives, or hammers, and discharging the shredded material out the other side virtually in the same plane without the use of any conveyor under the rotary knives or hammers, such as a steel slat conveyor.

6. A method of protecting the belt of the feeding conveyor from damage due to the proximity to the rotary knives or hammers by the use of a protective pulley or roller at the material feed input.
